(19) United States
(12) Patent Application Publication
(10) Pub. No.: US 2025/0148370 A1
(43) Pub. Date: May 8, 2025

(54) METHOD AND APPARATUS FOR INTELLIGENT OPERATING OF COMMUNICATION SYSTEM

(71) Applicant: Electronics and Telecommunications Research Institute, Daejeon (KR)

(72) Inventors: Yong Jin KWON, Daejeon (KR); Anseok LEE, Daejeon (KR); Seungjae BAHNG, Daejeon (KR); Heesoo LEE, Daejeon (KR); Yunjoo KIM, Daejeon (KR); Hyun Seo PARK, Daejeon (KR); Jungbo SON, Daejeon (KR); Yu Ro LEE, Daejeon (KR)

(21) Appl. No.: 18/935,381

(22) Filed: Nov. 1, 2024

(30) Foreign Application Priority Data
Nov. 3, 2023 (KR) 10-2023-0150745
Nov. 24, 2023 (KR) 10-2023-0166075
Mar. 26, 2024 (KR) 10-2024-0041278
May 10, 2024 (KR) 10-2024-0061937
Nov. 1, 2024 (KR) 10-2024-0153518

(51) Int. Cl. G06N 20/00

(52) U.S. Cl. CPC G06N 20/00

(57) ABSTRACT

A method of a first communication node may comprise: configuring at least one intelligent functionality among a plurality of intelligent functionalities based on functionality configuration information received from a second communication node; obtaining a training dataset corresponding to the at least one intelligent functionality based on an associated identifier (ID) received from the second communication node; training an intelligent model to perform the at least one intelligent functionality using the training dataset; and performing intelligent operations according to the at least one intelligent functionality using the trained intelligent model.

### CROSS-REFERENCE TO RELATED APPLICATIONS

This application claims priority to Korean Patent Applications No. 10-2023-0150745, filed on Nov. 3, 2023, No. 10-2023-0166075, filed on Nov. 24, 2023, No. 10-2024-0041278, filed on Mar. 26, 2024, No. 10-2024-0061937, filed on May 10, 2024, and No. 10-2024-0153518, filed on Nov. 1, 2024, with the Korean Intellectual Property Office (KIPO), the entire contents of which are hereby incorporated by reference.

### BACKGROUND

### 1. Technical Field

The present disclosure relates to an intelligent technique in a communication system, and more particularly, to an intelligent technique capable of managing dataset information for training an intelligent model of a communication node.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, there has been active discussion on leveraging intelligent technologies using artificial intelligence (AI) or machine learning (ML) in modern communication systems. The 3GPP is conducting research on intelligent technologies for NR air interfaces. The intelligent technologies in communication systems may be applied in areas such as enhancing Channel State Information (CSI) feedback, beam management, and positioning accuracy.

The intelligent technologies in a communication system may involve two or more communication nodes, such as a base station and a terminal, performing a specific intelligent functionality. Each communication node may be equipped with intelligent model(s) to perform the intelligent functionality. The intelligent model in each communication node may be trained using a dataset for training, and the trained intelligent model can perform intelligent operations for the specific intelligent functionality. Here, the communication system may perform life cycle management (LCM) for intelligent model(s) to create, maintain, or update the model(s) based on changes in data used for training the intelligent model(s).

In the conventional life cycle management method, a communication system manages datasets for training intelligent models by sharing detailed information, such as input and output data or internal structures of the intelligent models, between communication nodes.

However, the conventional dataset management method has raised issues of increased signaling overhead between the base station and terminal in the communication system, thereby necessitating the development of more efficient dataset management methods.

### SUMMARY

The present disclosure for resolving the above-described problems is directed to providing a method and apparatus for intelligent operations in a communication system, which facilitate management of datasets for training of intelligent models by sharing dataset information between communication nodes.

A method of a first communication node for intelligent operations, according to an exemplary embodiment of the present disclosure for achieving the above-described objective, may comprise: configuring at least one intelligent functionality among a plurality of intelligent functionalities based on functionality configuration information received from a second communication node; obtaining a training dataset corresponding to the at least one intelligent functionality based on an associated identifier (ID) received from the second communication node; training an intelligent model to perform the at least one intelligent functionality using the training dataset; and performing intelligent operations according to the at least one intelligent functionality using the trained intelligent model.

The configuring of the at least one intelligent functionality may comprise: in response to a capability information request received from the second communication node, transmitting, to the second communication node, a capability report including information on each of the plurality of intelligent functionalities supportable by the first communication node; in response to the functionality configuration information received from the second communication node based on the capability report, configuring the at least one intelligent functionality corresponding to the functionality configuration information among the plurality of intelligent functionalities; and transmitting a completion report to the second communication node upon completion of the configuring of the at least one intelligent functionality.

The method may further comprise: after configuring the at least one intelligent functionality, transmitting additional information to the second communication node; receiving functionality reconfiguration information from the second communication node based on the additional information; and reconfiguring the at least one intelligent functionality by incorporating the additional information based on the functionality reconfiguration information.

The method may further comprise: after configuring the at least one intelligent functionality, receiving additional information and functionality reconfiguration information from the second communication node; and reconfiguring the at least one intelligent functionality by incorporating the additional information based on the functionality reconfiguration information.

The obtaining of the training dataset may comprise: receiving dataset information corresponding to the at least one intelligent functionality from the second communication node; and receiving a dataset corresponding to the dataset information from the second communication node and acquiring the dataset as the training dataset.

The obtaining of the training dataset may comprise: collecting a plurality of data units based on data collection configuration information received from the second communication node; in response to receipt of a data request signal from the second communication node, transmitting the plurality of data units to the second communication node; and receiving a dataset including one or more data units corresponding to the at least one intelligent functionality among the plurality of data units from the second communication node and acquiring the dataset as the training dataset.

The obtaining of the training dataset may comprise: transmitting configuration change information of the first communication node to the second communication node, and the transmitting of the plurality of data units to the second communication node may comprise: transmitting the plurality of data units collected up to a time of changing configuration of the first communication node to the second communication node upon receipt of a data request signal transmitted from the second communication node based on the configuration change information.

The obtaining of the training dataset may comprise: receiving the associated ID and reference signals (RSs) from the second communication node; and collecting a plurality of data units corresponding to the at least one intelligent functionality based on the RSs and the associated ID and acquiring the plurality of data units as the training dataset.

The method may further comprise: after the training of the intelligent model, transmitting model information for the intelligent model to the second communication node.

The performing of the intelligent operations may comprise: operating the intelligent model to perform the at least one intelligent functionality based on a function activation signal received from the second communication node; and deactivating operations of the intelligent model based on a function deactivation signal received from the second communication node.

A first communication node for intelligent operations, according to an exemplary embodiment of the present disclosure for achieving the above-described objective, may comprise at least one processor, wherein the at least one processor causes the first communication node to perform: configuring at least one intelligent functionality among a plurality of intelligent functionalities based on functionality configuration information received from a second communication node; obtaining a training dataset corresponding to the at least one intelligent functionality based on an associated identifier (ID) received from the second communication node; training an intelligent model to perform the at least one intelligent functionality using the training dataset; and performing intelligent operations according to the at least one intelligent functionality using the trained intelligent model.

In the configuring of the at least one intelligent functionality, the at least one processor may cause the first communication node to perform: in response to a capability information request received from the second communication node, transmitting, to the second communication node, a capability report including information on each of the plurality of intelligent functionalities supportable by the first communication node; in response to the functionality configuration information received from the second communication node based on the capability report, configuring the at least one intelligent functionality corresponding to the functionality configuration information among the plurality of intelligent functionalities; and transmitting a completion report to the second communication node upon completion of the configuring of the at least one intelligent functionality.

The at least one processor may further cause the first communication node to perform: after configuring the at least one intelligent functionality, transmitting additional information to the second communication node; receiving functionality reconfiguration information from the second communication node based on the additional information; and reconfiguring the at least one intelligent functionality by incorporating the additional information based on the functionality reconfiguration information.

The at least one processor may further cause the first communication node to perform: after configuring the at least one intelligent functionality, receiving additional information and functionality reconfiguration information from the second communication node; and reconfiguring the at least one intelligent functionality by incorporating the additional information based on the functionality reconfiguration information.

In the obtaining of the training dataset, the at least one processor may cause the first communication node to perform: receiving dataset information corresponding to the at least one intelligent functionality from the second communication node; and receiving a dataset corresponding to the dataset information from the second communication node and acquiring the dataset as the training dataset.

In the obtaining of the training dataset, the at least one processor may cause the first communication node to perform: collecting a plurality of data units based on data collection configuration information received from the second communication node; in response to receipt of a data request signal from the second communication node, transmitting the plurality of data units to the second communication node; and receiving a dataset including one or more data units corresponding to the at least one intelligent functionality among the plurality of data units from the second communication node and acquiring the dataset as the training dataset.

In the obtaining of the training dataset, the at least one processor may cause the first communication node to perform: transmitting configuration change information of the first communication node to the second communication node, and in the transmitting of the plurality of data units to the second communication node, the at least one processor may cause the first communication node to perform: transmitting the plurality of data units collected up to a time of changing configuration of the first communication node to the second communication node upon receipt of a data request signal transmitted from the second communication node based on the configuration change information.

In the obtaining of the training dataset, the at least one processor may cause the first communication node to perform: receiving the associated ID and reference signals (RSs) from the second communication node; and collecting a plurality of data units corresponding to the at least one intelligent functionality based on the RSs and the associated ID and acquiring the plurality of data units as the training dataset.

The at least one processor may further cause the first communication node to perform: after the training of the intelligent model, transmitting model information for the intelligent model to the second communication node.

In the performing of the intelligent operations, the at least one processor may cause the first communication node to perform: operating the intelligent model to perform the at least one intelligent functionality based on a function activation signal received from the second communication node; and deactivating operations of the intelligent model based on a function deactivation signal received from the second communication node.

According to the present disclosure, a first communication node and a second communication node in a communication system can share dataset information and manage dataset(s) for training intelligent models based on the shared dataset information. As a result, it is made possible to manage dataset(s) for training intelligent models without sharing detailed information on the intelligent models between the first communication node and the second communication node, thereby reducing the overhead in the communication system. Furthermore, the first communication node or the second communication node can train intelligent models using training datasets corresponding to the shared dataset information, thereby improving the training performance of the models.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating a structure of intelligent features.

FIG. 4 is a conceptual diagram illustrating an example of intelligent feature.

FIG. 5 is a conceptual diagram illustrating an example of intelligent feature.

FIG. 6 is a conceptual diagram illustrating a relationship between intelligent functionalities and intelligent models.

FIG. 7 is a flowchart illustrating exemplary embodiments of a method for intelligent operations of a communication node.

FIG. 8 is a sequence chart illustrating an exemplary embodiment of a method for configuring an intelligent functionality of a communication node.

FIG. 9 is a sequence chart illustrating an exemplary embodiment of a method for configuring an intelligent functionality of a communication node.

FIG. 10 is a sequence chart illustrating an exemplary embodiment of a method for configuring an intelligent functionality of a communication node.

FIG. 11 is a conceptual diagram illustrating a relationship between intelligent functionalities and multiple pieces of dataset information.

FIG. 12 is a sequence chart illustrating an exemplary embodiment of a method for sharing dataset information.

FIG. 13 is a sequence chart illustrating an exemplary embodiment of a method for sharing dataset information.

FIG. 14 is a sequence chart illustrating an exemplary embodiment of a method for sharing dataset information.

FIG. 15 is a sequence chart illustrating other exemplary embodiments of a method for sharing dataset information.

FIG. 16 is a sequence chart illustrating other exemplary embodiments of a method for sharing dataset information.

FIG. 17 is a sequence chart illustrating an exemplary embodiment of a method for acquiring a training dataset.

FIG. 18 is a sequence chart illustrating an exemplary embodiment of a method for acquiring a training dataset.

FIG. 19 is a sequence chart illustrating an exemplary embodiment of a method for acquiring a training dataset.

FIG. 20 is a sequence chart illustrating an exemplary embodiment of a method for acquiring a training dataset.

FIG. 21 is a sequence chart illustrating an exemplary embodiment of a method for acquiring a training dataset.

FIG. 22 is a sequence chart illustrating an exemplary embodiment of a method for acquiring a training dataset.

FIG. 23 is a sequence chart illustrating an exemplary embodiment of a method for training an intelligent model using a training dataset.

FIG. 24 is a sequence chart illustrating an exemplary embodiment of a method for training an intelligent model using a training dataset.

FIG. 25 is a sequence chart illustrating an exemplary embodiment of a method for training an intelligent model using a training dataset.

FIG. 26 is a sequence chart illustrating an exemplary embodiment of a method for training an intelligent model using a training dataset.

FIG. 27 is a sequence chart illustrating an exemplary embodiment of a method for training an intelligent model using a training dataset.

FIG. 28 is a conceptual diagram illustrating a relationship between intelligent functionalities and associated IDs.

FIG. 29 is a sequence chart illustrating other exemplary embodiments of a method for training an intelligent model using a training dataset.

FIG. 30 is a sequence chart illustrating other exemplary embodiments of a method for training an intelligent model using a training dataset.

FIG. 31 is a sequence chart illustrating other exemplary embodiments of a method for training an intelligent model using a training dataset.

FIG. 32 is a conceptual diagram illustrating a relationship among intelligent functionalities, associated IDs, and model IDs.

FIG. 33 is a sequence chart illustrating exemplary embodiments of an intelligent operation method for a communication node using an intelligent model.

FIG. 34 is a conceptual diagram illustrating an exemplary embodiment to which an intelligent technique is applied.

FIG. 35 is a conceptual diagram illustrating an exemplary embodiment to which an intelligent technique is applied.

FIG. 36 is a conceptual diagram illustrating an exemplary embodiment to which an intelligent technique is applied.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like. Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

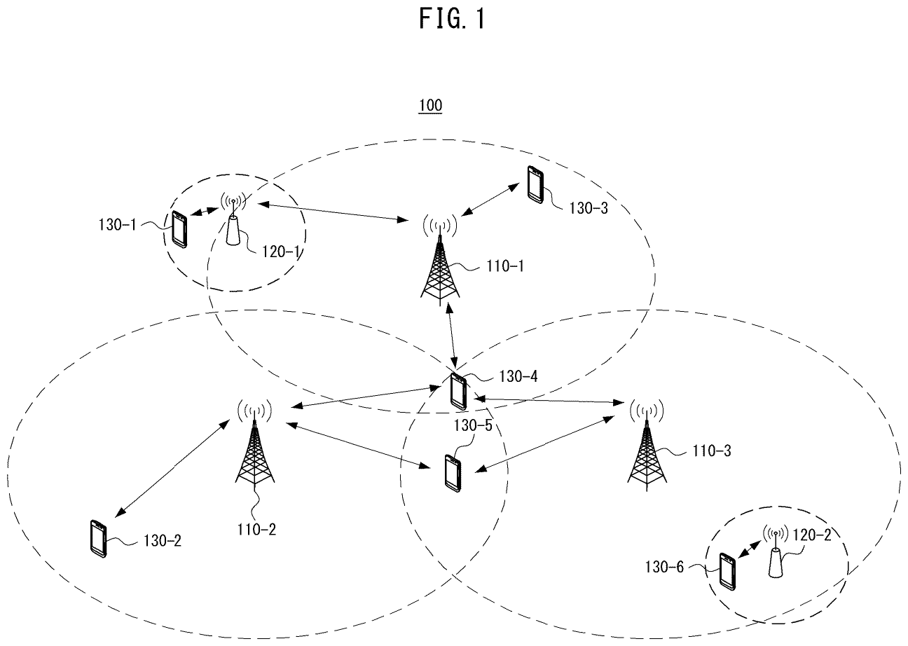

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

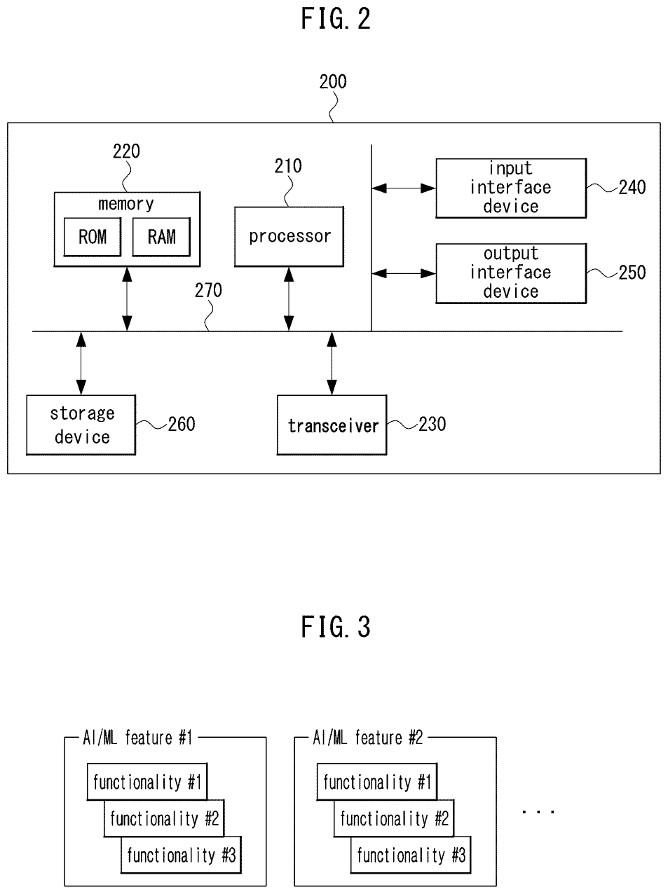

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

The above-described communication node 200 may include one or more AI/ML models, for example, intelligent models, to perform a specific intelligent functionality. The intelligent models may be installed in the memory 220 or storage device 260 of the communication node 200.

The intelligent model of the communication node 200 may be classified as a one-sided model or a two-sided model, depending on a form of intelligent operations performed to execute the intelligent functionality. For example, when an intelligent model installed in a single communication node is used to perform intelligent operations corresponding to a specific intelligent functionality, the intelligent model may be classified as a one-sided model. Additionally, when intelligent models installed in two or more communication nodes are collectively used to perform intelligent operations corresponding to a specific intelligent functionality, the intelligent models may be a two-sided model.

To ensure that the intelligent model performs the intelligent functionality, training of the intelligent model may be required. The training of the intelligent model may be performed based on training data corresponding to the intelligent functionality to be performed. Accordingly, the communication node 200 may perform life cycle management (LCM) for the training and utilization of the intelligent model.

The LCM of the intelligent model may include creation, maintenance, or update of the intelligent functionality or model, depending on changes in training data. The LCM may include detailed steps such as data collection, model training, model inference, model deployment, model activation, model deactivation, model selection, model switching, model fallback, and model monitoring.

Furthermore, the communication node 200 may perform identification of functionalities or models before performing the LCM. For example, a base station among the communication nodes 200 may identify intelligent functionalities or models supportable by a terminal and may activate a specific intelligent functionality or model of the terminal based on the identified intelligent functionalities or models.

The communication node 200 may perform functionality-based LCM or model-based LCM for intelligent models through the identification of intelligent functionalities and models. The functionality-based LCM may refer to an LCM process where a base station (or a base station-side server) and a terminal (or a terminal-side server) among the communication nodes 200 share functionality information for intelligent functionalities in advance and subsequently use the functionality information or functionality IDs to identify and manage the intelligent functionalities. The model-based LCM may refer to an LCM process where a base station and a terminal share intelligent model information in advance and subsequently use the model information to identify and manage the intelligent models.

Regarding the LCM of intelligent models, the 3GPP is discussing a method where functionality-based LCM is used as the default, while model-based LCM is used in specific scenarios or a method where certain functions of model-based LCM are integrated into functionality-based LCM.

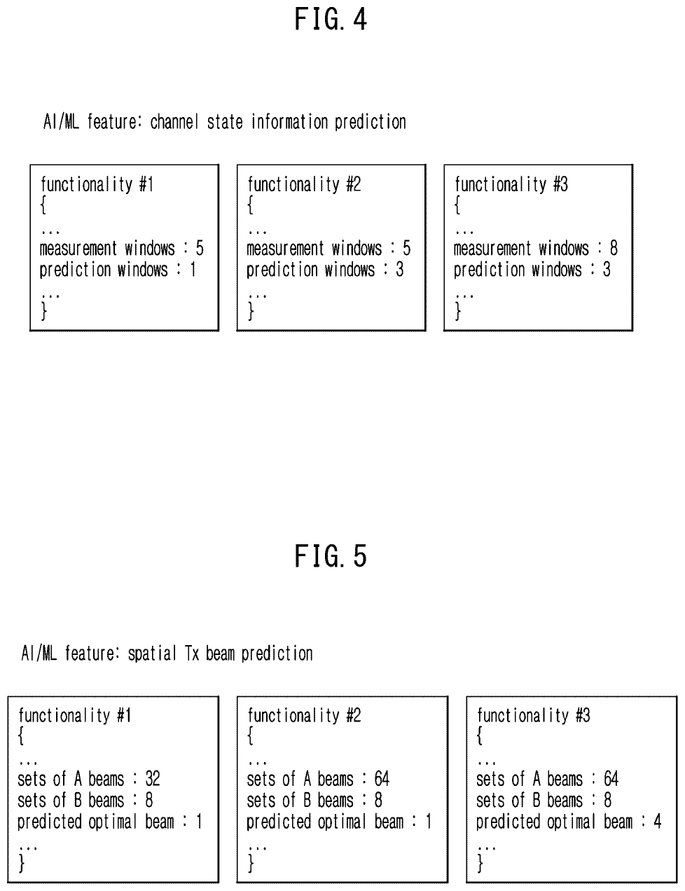

FIG. 3 is a conceptual diagram illustrating a structure of intelligent features, and FIGS. 4 and 5 are conceptual diagrams illustrating examples of intelligent features.

Referring to FIG. 3, an AI/ML feature, for example, intelligent feature, may include multiple functionalities, for example, intelligent functionalities. Each of the multiple intelligent functionalities may include configuration for the intelligent feature (or feature group). The intelligent feature may be information configured for intelligent operations of the communication node 200.

Referring to FIG. 4, if an intelligent feature is related to Channel State Information (CSI) prediction for the communication node 200, the intelligent feature may include multiple intelligent functionalities, each including one or more configuration values for CSI prediction.

For example, the intelligent feature for CSI prediction may include multiple intelligent functionalities with different configuration values for CSI-RS information for CSI prediction. In this case, the multiple intelligent functionalities may have different values for the number of measurement windows or the number of prediction windows for CSI prediction.

Referring to FIG. 5, if an intelligent feature is related to spatial Tx beam prediction in for the communication node 200, the intelligent feature may include multiple intelligent functionalities, each including one or more configuration values for spatial Tx beam prediction. Here, the multiple intelligent functionalities may have different values for the number of sets (or configurations) of A beams, the number of sets of B beams, or the number of predicted optimal sets for spatial Tx beam prediction. Here, A beams may represent all Tx beams, and B beams may represent measured Tx beams.

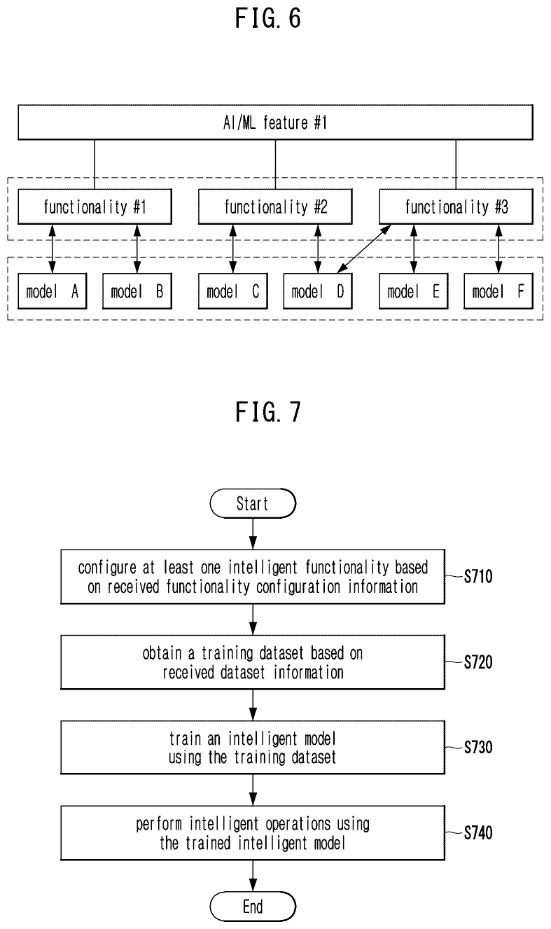

FIG. 6 is a conceptual diagram illustrating a relationship between intelligent functionalities and intelligent models.

Referring to FIG. 6, the communication node 200 may include at least one intelligent feature for intelligent operations, and one intelligent feature may include multiple intelligent functionalities. Additionally, each of the multiple intelligent functionalities may be associated with multiple AI/ML models, for example, intelligent models.

For example, one intelligent feature may include three intelligent functionalities, and each intelligent functionality may be associated with two intelligent models. Here, each of the multiple intelligent models may be mapped one-to-one to each of the multiple intelligent functionalities. Moreover, in some exemplary embodiments, at least one of the multiple intelligent models may be mapped to and associated with two or more intelligent functionalities.

As shown in FIG. 6, an intelligent model capable of performing intelligent operations may have a structure associated with intelligent functionalities. Accordingly, the communication node 200 may perform LCM of intelligent models based on intelligent functionalities.

FIG. 7 is a flowchart illustrating exemplary embodiments of a method for intelligent operations of a communication node.

For convenience of description, one of the communication nodes 200 in the communication system 100 will be referred to as a first communication node (e.g. terminal), and another communication node will be referred to as a second communication node (e.g. base station). Furthermore, intelligent operations of a communication node in the present disclosure will be described based on an example of LCM for an intelligent model installed in the first communication node. However, the present disclosure is not limited thereto, and the intelligent operations of the communication node may involve LCM for an intelligent model installed in the second communication node.

Referring to FIG. 7, the first communication node may configure at least one intelligent functionality for intelligent operations of an intelligent model based on functionality configuration information received from the second communication node (S710). Based on the configuration of the intelligent functionality in the first communication node, the second communication node may share information on the at least one intelligent functionality configured in the first communication node.

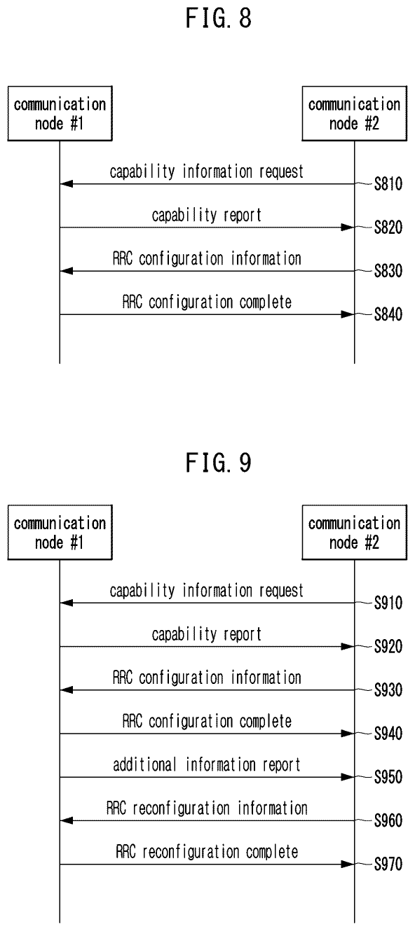

FIGS. 8 to 10 are sequence charts illustrating exemplary embodiments of methods for configuring an intelligent functionality of a communication node.

Referring to FIG. 8, the second communication node may request node capability information from the first communication node for intelligent functionality configuration (S810).

The first communication node may receive a node capability information request from the second communication node. In response to the node capability information request from the second communication node, the first communication node may generate a capability report including information on each of multiple intelligent functionalities supportable by the first communication node, such as information on key parameters of each of the multiple intelligent functionalities, and may transmit the capability report to the second communication node (S820).

Based on the capability report received from the first communication node, the second communication node may transmit functionality configuration information (e.g. RRC configuration information) for configuring at least one intelligent functionality to the first communication node (S830).

The first communication node may configure at least one intelligent functionality corresponding to the functionality configuration information included in the received functionality configuration information among the multiple intelligent functionalities. Upon completing the configuration of the intelligent functionality, the first communication node may transmit a configuration completion report to the second communication node (S840). Through the configuration completion report from the first communication node, the second communication node may share information on the at least one intelligent functionality configured in the first communication node.

Referring to FIG. 9, the first communication node may reconfigure the at least one configured intelligent functionality based on additional information.

The second communication node may request node capability information from the first communication node (S910). The first communication node may receive the capability information request from the second communication node. Based on the request from the second communication node, the first communication node may generate a capability report that includes information for each of multiple intelligent functionalities supportable by the first communication node and transmit the capability report to the second communication node (S920).

The second communication node may transmit functionality configuration information to the first communication node to configure at least one intelligent functionality, based on the capability report from the first communication node (S930). The first communication node may configure at least one intelligent functionality corresponding to the functionality configuration information included in the received functionality configuration information among the multiple intelligent functionalities, and may transmit a configuration completion report to the second communication node (S940).

The first communication node may transmit the additional information (e.g. additional information of the first communication node for the configured intelligent functionality) to the second communication node (S950). Here, the additional information of the first communication node may include at least one of beam configuration information or device information of the first communication node. The beam configuration information may include at least one of an Rx beam pattern or a beam angle of the first communication node. The device information may include at least one of a memory state, battery state, or processing capability of a processor of the first communication node.

The second communication node may transmit intelligent functionality reconfiguration information (e.g. RRC reconfiguration information) to the first communication node based on the additional information transmitted by the first communication node (S960). In some exemplary embodiments, the second communication node may update the intelligent functionality of the first communication node that has been previously shared, based on the additional information of the first communication node.

The first communication node may reconfigure the configured intelligent functionality by incorporating the additional information based on the functionality reconfiguration information received from the second communication node, and may transmit a reconfiguration completion report to the second communication node (S970).

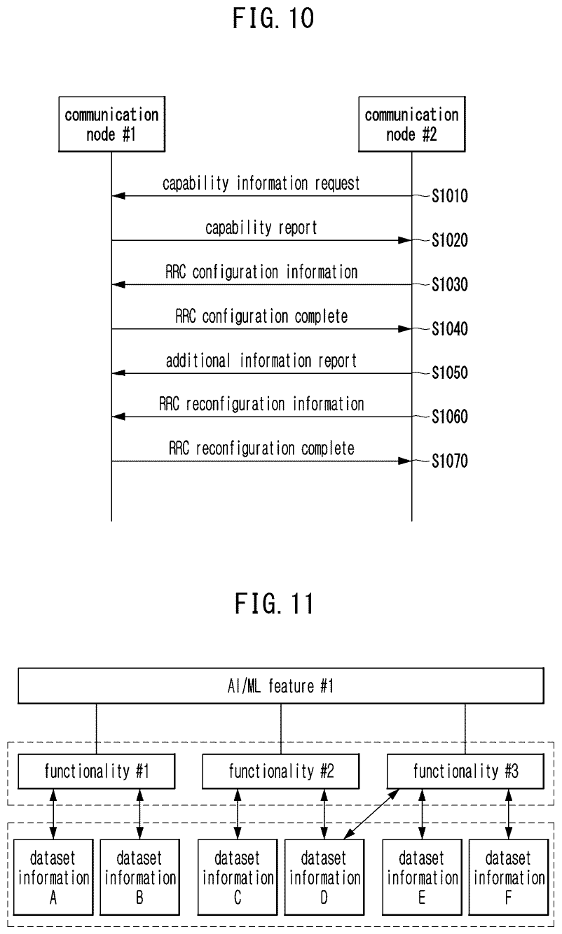

Referring to FIG. 10, the first communication node may configure at least one intelligent functionality through a step S1010 of receiving a capability information request from the second communication node; a step S1020 of transmitting a capability report to the second communication node; a step S1030 of receiving functionality configuration information from the second communication node; and a step S1040 of configuring an intelligent functionality based on the functionality configuration information and transmitting a configuration completion report to the second communication node.

The second communication node may transmit additional information (e.g. additional information of the second communication node for the intelligent functionality of the first communication node that has been previously shared) to the first communication node (S1050). Subsequently, the second communication node may transmit intelligent functionality reconfiguration information to the first communication node based on the additional information (S1060).

The additional information of the second communication node may include at least one of beam configuration information, for example, a Tx beam pattern or a beam angle of the second communication node. In some exemplary embodiments, the second communication node may also update the previously shared intelligent functionality of the first communication node based on the additional information.

The first communication node may reconfigure the configured intelligent functionality by incorporating the additional information based on the functionality reconfiguration information received from the second communication node. The first communication node may transmit a reconfiguration completion report to the second communication node regarding the reconfigured intelligent functionality (S1070).

Referring again to FIG. 7, the first communication node may receive dataset information from the second communication node, and may share a dataset with the second communication node. The first communication node may obtain a training dataset for training the intelligent model based on the shared dataset information (S720).

FIG. 11 is a conceptual diagram illustrating a relationship between intelligent functionalities and multiple pieces of dataset information.

Referring to FIG. 11, the first communication node one intelligent feature, the one intelligent feature may include multiple intelligent functionalities, and each of the multiple intelligent functionalities may be associated with multiple pieces of dataset information. Each of the multiple pieces of dataset information may be associated one-to-one with each intelligent functionality or may be mapped to and associated with two or more intelligent functionalities.

Each dataset information may include at least one data information, such as a dataset ID, the number of dataset samples, the total size of a dataset, or an operator constituting the dataset, for training an intelligent model.

As shown in FIG. 11, each of the multiple pieces of dataset information may be associated with the intelligent functionality configured in the first communication node. Accordingly, each of the multiple pieces of dataset information may include association information corresponding to the intelligent functionality, such as associated ID, along with the above-described data information.

The associated ID may serve as an identifier that can be used to deliver configuration changes for the configured intelligent functionality of the first communication node or the second communication node to maintain performance consistency between training operations and actual operations, such as inference operations, of the intelligent model. For example, the second communication node may include configuration changes of its intelligent functionality in dataset information using an associated ID, and may transmit the dataset information to the first communication node. Based on the associated ID of the received dataset information, the first communication node may obtain a training dataset for training the intelligent model in the same environment as the second communication node, specifically in the environment where the intelligent functionality has been changed.

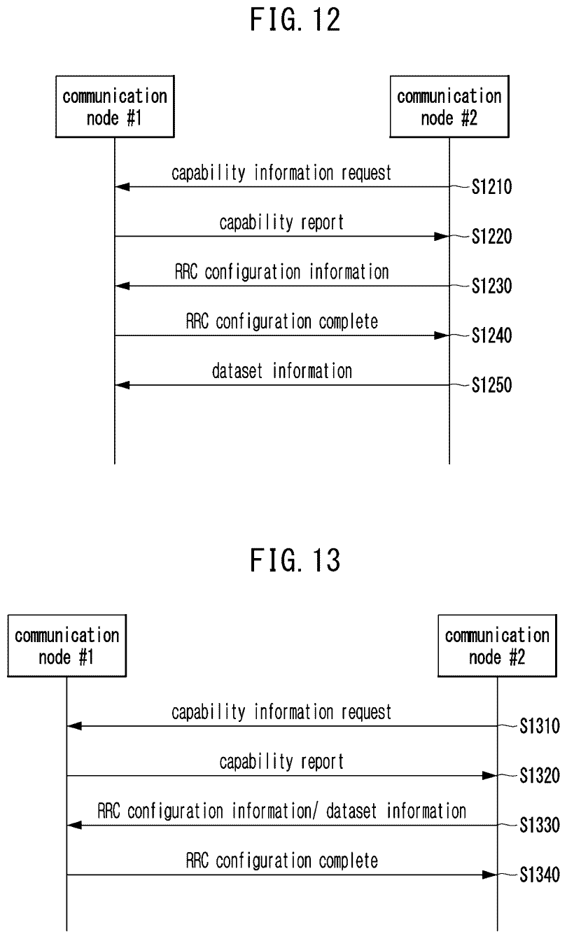

FIGS. 12 to 14 are sequence charts illustrating exemplary embodiments of methods for sharing dataset information.

Hereinafter, with reference to FIGS. 12 to 14, methods for sharing dataset information between the first communication node and the second communication node will be described in detail, assuming the intelligent model of the first communication node is a one-sided model. Here, the one-sided model may refer to performing intelligent operations using the intelligent model of the first communication node.

Referring to FIG. 12, the first communication node may configure at least one intelligent functionality through a step S1210 of receiving a node capability information request from the second communication node; a step S1220 of transmitting a capability report to the second communication node; a step S1230 of receiving functionality configuration information from the second communication node; and a step S1240 of configuring at least one intelligent functionality according to the functionality configuration information and transmitting a configuration completion report to the second communication node.

After the intelligent functionality of the first communication node is configured, the second communication node may transmit dataset information corresponding to the configured intelligent functionality to the first communication node. The first communication node and the second communication node may share the dataset information (S1250).

Referring to FIG. 13, the second communication node may request node capability information from the first communication node (S1310). The first communication node may generate a capability report including information on multiple intelligent functionalities supportable by the first communication node according to the request of the second communication node, and transmit the capability report to the second communication node (S1320).

The second communication node may transmit functionality configuration information for configuring at least one intelligent functionality to the first communication node based on the capability report of the first communication node. Along with this, the second communication node may transmit dataset information corresponding to the intelligent functionality included in the functionality configuration information to the first communication node. Accordingly, the first communication node and the second communication node may share the dataset information (S1330).

The first communication node may configure at least one intelligent functionality corresponding to the intelligent functionality included in the functionality configuration information, among multiple intelligent functionalities, based on the functionality configuration information received from the second communication node, and transmit a configuration completion report to the second communication node (S1340).

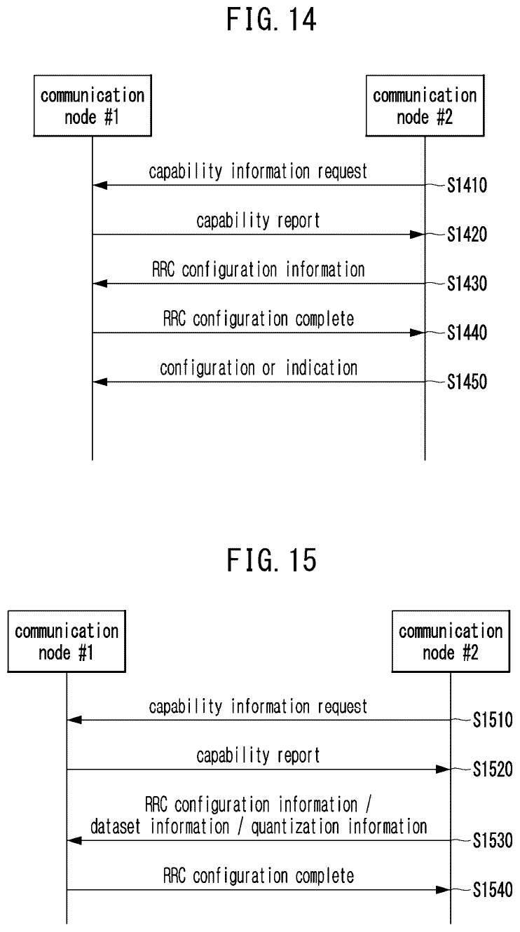

Referring to FIG. 14, the first communication node may configure at least one intelligent functionality through a step S1410 of receiving a node capability information request from the second communication node; a step S1420 of transmitting a capability report to the second communication node; a step S1430 of receiving functionality configuration information from the second communication node; and a step S1440 of configuring at least one intelligent functionality based on the functionality configuration information and transmitting a configuration completion report to the second communication node.

After the intelligent functionality of the first communication node is configured, the second communication node may share the dataset information through configurations for dataset acquisition corresponding to the shared intelligent functionality of the first communication node or through a method of indicating information related thereto (S1450). For example, the second communication node may configure a dataset in a given environment, assign dataset information corresponding to the dataset, and share the assigned dataset information with the first communication node.

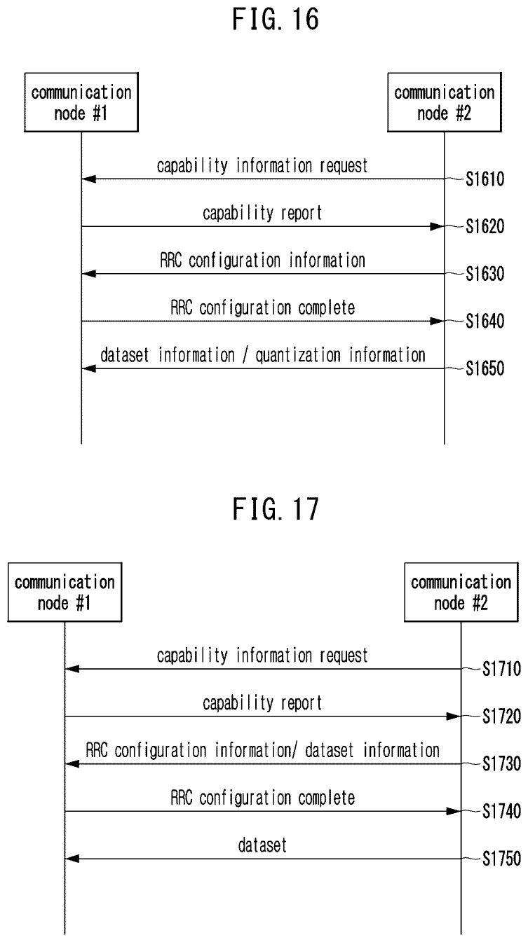

FIGS. 15 and 16 are sequence charts illustrating other exemplary embodiments of methods for sharing dataset information.

Hereinafter, with reference to FIGS. 15 and 16, methods for sharing dataset information between the first communication node and the second communication node will be described in detail, assuming the intelligent model of the first communication node belongs to a two-sided model.

Here, the two-sided model may refer to performing intelligent operations using the intelligent models of both the first communication node and the second communication node together. For example, if the intelligent feature of both the first communication node and the second communication node is CSI compression, at least one intelligent functionality may be configured for the intelligent feature at each of the first communication node and the second communication node, with respect to at least one of the number of transmission (Tx) antennas constituting a channel or precoding matrix, a rank representing the number of layers, or resource blocks of a frequency band.

Additionally, for the aforementioned intelligent feature, the intelligent models of both the first communication node and the second communication node may require at least one piece of information, such as quantization information for CSI transmitted in a latent space between an encoder of the first communication node and a decoder of the second communication node, for example, the number of CSI payload bits or a quantization scheme. The quantization information may be shared along with the dataset information during the above-described intelligent functionality configuration step, or may be shared after the configuration of the intelligent functionality along with the dataset information.

Referring to FIG. 15, the second communication node may request node capability information from the first communication node (S1510). The first communication node may generate a capability report including information on multiple intelligent functionalities supportable by the first communication node, and transmit the capability report to the second communication node (S1520).

Based on the capability report of the first communication node, the second communication node may transmit functionality configuration information for configuring at least one intelligent functionality to the first communication node. Along with this, the second communication node may transmit dataset information corresponding to the intelligent functionality included in the functionality configuration information and quantization information related to the intelligent models of both the first communication node and the second communication node to the first communication node. Accordingly, the first communication node and the second communication node may share the dataset information and quantization information (S1530).

The first communication node may configure at least one intelligent functionality corresponding to the intelligent functionality included in the functionality configuration information among multiple intelligent functionalities based on the functionality configuration information received from the second communication node, and may transmit a configuration completion report to the second communication node (S1540).

Referring to FIG. 16, the first communication node may configure at least one intelligent functionality through a step S1610 of receiving a node capability information request from the second communication node; a step S1620 of transmitting a capability report to the second communication node; a step S1630 of receiving functionality configuration information from the second communication node; and a step S1640 of configuring at least one intelligent functionality based on the functionality configuration information and transmitting a configuration completion report to the second communication node.

After the intelligent functionality of the first communication node is configured, the second communication node may transmit dataset information corresponding to the intelligent functionality included in the functionality configuration information and quantization information related to the intelligent models of both the first communication node and the second communication node to the first communication node. Accordingly, the first communication node and the second communication node may share the dataset information and quantization information (S1650).

FIGS. 17 to 22 are sequence charts illustrating exemplary embodiments of methods for acquiring a training dataset.

As described above, the first communication node may share dataset information with the second communication node and acquire a training dataset for training the intelligent model based on the shared dataset information.

Referring to FIG. 17, the second communication node may request node capability information from the first communication node (S1710). The first communication node may generate a capability report including information on multiple intelligent functionalities supportable by the first communication node, and transmit the capability report to the second communication node (S1720).

Based on the capability report of the first communication node, the second communication node may transmit functionality configuration information for configuring at least one intelligent functionality to the first communication node. Along with this, the second communication node may transmit dataset information corresponding to the intelligent functionality included in the functionality configuration information to the first communication node. Accordingly, the first communication node and the second communication node may share the dataset information (S1730).

The first communication node may configure at least one intelligent functionality corresponding to the intelligent functionality included in the functionality configuration information among multiple intelligent functionalities based on the functionality configuration information received from the second communication node, and may transmit a configuration completion report to the second communication node (S1740).

After the intelligent functionality of the first communication node is configured and the dataset information is shared, the second communication node may transmit a dataset to the first communication node, where the dataset includes one or more data units corresponding to the shared dataset information. Accordingly, the first communication node may acquire the dataset received from the second communication node as a training dataset (S1750).

As described above with reference to FIG. 11, the dataset information shared between the first communication node and the second communication node may include an associated ID related to the configuration of one or more intelligent functionalities of the first communication node. Therefore, the first communication node may acquire the dataset from the second communication node based on the associated ID of the dataset information, where the dataset includes a set of one or more data units associated with one or more intelligent functionalities.

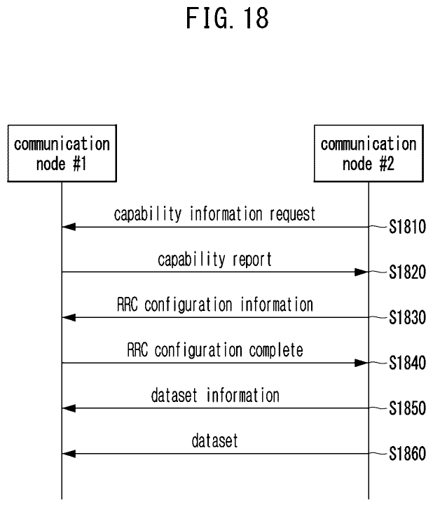

Referring to FIG. 18, the first communication node may configure at least one intelligent functionality through a step S1810 of receiving a node capability information request from the second communication node; a step S1820 of transmitting a capability report to the second communication node; a step S1830 of receiving functionality configuration information from the second communication node; and a step S1840 of configuring at least one intelligent functionality based on the functionality configuration information and transmitting a configuration completion report to the second communication node.

After the intelligent functionality of the first communication node is configured, the second communication node may transmit dataset information corresponding to the configured intelligent functionality to the first communication node. Accordingly, the first communication node and the second communication node may share the dataset information (S1850). As described above, the dataset information may include an associated ID related to the configuration of one or more intelligent functionalities of the first communication node.

In the state where the first communication node and the second communication node share the dataset information, the second communication node may transmit a dataset, which includes one or more data units, to the first communication node based on the associated ID of the shared dataset information. Accordingly, the first communication node may acquire the dataset received from the second communication node as a training dataset (S1860).

On the other hand, the second communication node may also transmit the dataset to the first communication node without sharing dataset information.

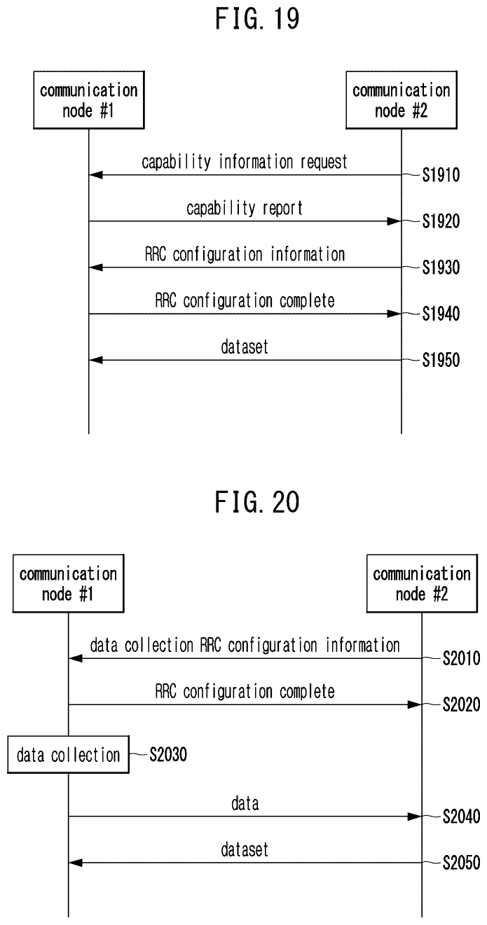

Referring to FIG. 19, the first communication node may configure at least one intelligent functionality through a step S1910 of receiving a node capability information request from the second communication node; a step S1920 of transmitting a capability report to the second communication node; a step S1930 of receiving functionality configuration information from the second communication node; and a step S1940 of configuring at least one intelligent functionality based on the functionality configuration information and transmitting a configuration completion report to the second communication node.

After the intelligent functionality of the first communication node is configured, the second communication node may transmit a dataset, which includes one or more data units corresponding to the intelligent functionality configured in the first communication node, to the first communication node (S1950).

The second communication node may transmit dataset information, including an associated ID, along with the dataset. The dataset information may include at least one data information, such as a dataset ID, the number of dataset samples, the total size of a dataset, or an operator constituting the dataset, along with the associated ID related to the configuration of the at least one intelligent functionality. Additionally, in some exemplary embodiments, the second communication node may transmit at least one piece of information on a specific dimension or size of input or output of the dataset to the first communication node along with the dataset.

As described with reference to FIGS. 17 through 19, the second communication node may transmit the dataset, including one or more data units for training the intelligent model of the first communication node, to the first communication node according to the at least one intelligent functionality configured in the first communication node.

Here, the dataset transmitted by the second communication node to the first communication node may have a relatively large size compared to other signals, such as dataset information. Accordingly, as shown in FIGS. 17 and 18, when dataset information is shared between the first communication node and the second communication node, the second communication node may transmit the dataset to the first communication node through offline data transfer. However, as shown in FIG. 19, when dataset information is not shared between the first communication node and the second communication node, the second communication node may transmit the dataset to the first communication node through a dataset transfer such as 3GPP signaling.

As described above, in the present disclosure, the first communication node may acquire a training dataset for training its intelligent model through the sharing of dataset information, even without sharing detailed information on its intelligent model with the second communication node. Accordingly, signaling overhead resulting from the sharing of detailed information on the intelligent model between the first communication node and the second communication node can be prevented.

The method by which the first communication node acquires the dataset transmitted by the second communication node as a training dataset has been described with reference to FIGS. 17 to 19. However, in the present disclosure, the first communication node may also acquire training data based on data collected by the first communication node itself.

Referring to FIG. 20, the second communication node may transmit configuration information for data collection, such as data collection RRC configuration information, to the first communication node (S2010). The first communication node may complete the configuration for data collection based on the received data collection RRC configuration information and transmit a configuration completion report to the second communication node (S2020).

Although not shown in FIG. 20, before the second communication node transmits the RRC configuration information for data collection to the first communication node, the second communication node may perform the step of configuring at least one intelligent functionality of the first communication node.

Once the data collection configuration of the first communication node is completed, the first communication node may collect multiple data units corresponding to the surrounding environment (S2030) and transmit the collected multiple data units to the second communication node (S2040). The data collection operation of the first communication node may not require strict time requirements. Therefore, instead of transmitting data units to the second communication node as they are collected, the first communication node may store the collected data units internally and transmit the stored multiple data units according to a preconfigured transmission periodicity. This can reduce signaling overhead between the first communication node and the second communication node.

The second communication node may classify and store the multiple data units received from the first communication node by corresponding intelligent functionalities. The second communication node may transmit a dataset, including one or more data units corresponding to the configured intelligent functionality of the first communication node, to the first communication node. The first communication node may acquire the dataset received from the second communication node as a training dataset (S2050).

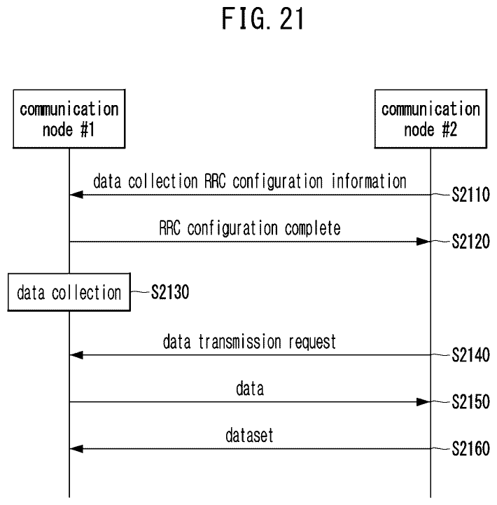

Referring to FIG. 21, the second communication node may transmit RRC configuration information for data collection to the first communication node (S2110). The first communication node may complete the configuration for data collection based on the received data collection RRC configuration information and transmit a configuration completion report to the second communication node (S2120).

Additionally, before the second communication node transmits the RRC configuration information for data collection to the first communication node, the step of configuring at least one intelligent functionality of the first communication node may be performed.

Once the data collection configuration of the first communication node is completed, the first communication node may collect multiple data units corresponding to the surrounding environment (S2130). The second communication node may transmit a data request signal to the first communication node at a preconfigured periodicity, in other words, at each transmission period for the collected data units (S2140).

The first communication node may transmit the collected multiple data units to the second communication node based on the data request signal received from the second communication node (S2150). The second communication node may classify and store the multiple data units received from the first communication node by corresponding intelligent functionalities. The second communication node may transmit a dataset, including one or more data units corresponding to the configured intelligent functionality of the first communication node, to the first communication node. The first communication node may acquire the dataset received from the second communication node as a training dataset (S2160).

Meanwhile, the configuration of the first communication node may change while the first communication node is collecting data units. In this case, the data collected by the first communication node may have different characteristics compared to the data collected at a previous point in time, namely, before the configuration change. Accordingly, the first communication node may report the changes in its configuration to the second communication node and, based on this, may transmit the collected multiple data units to the second communication node.

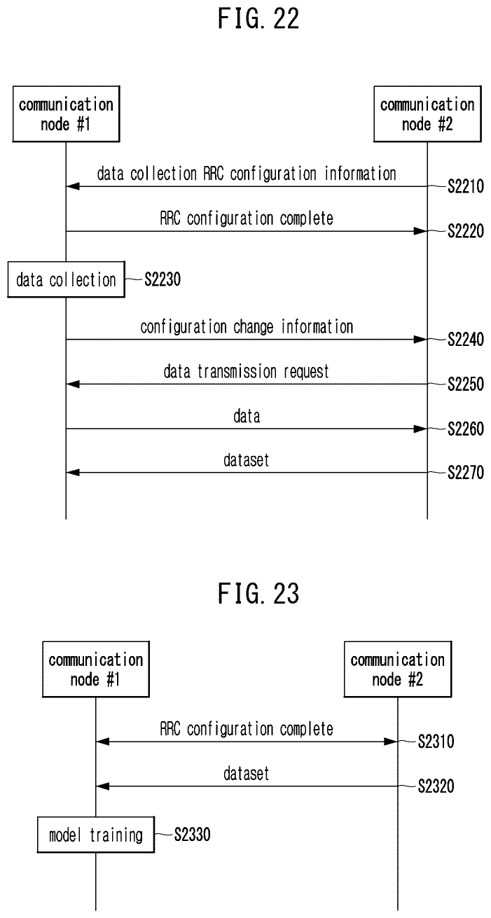

Referring to FIG. 22, the second communication node may transmit data collection RRC configuration information to the first communication node (S2210). The first communication node may complete the configuration for data collection based on the received data collection RRC configuration information and transmit a configuration completion report to the second communication node (S2220).

Additionally, before the second communication node transmits the RRC configuration information for data collection to the first communication node, a step of configuring at least one intelligent functionality of the first communication node may be performed.

Once the data collection configuration of the first communication node is completed, the first communication node may collect multiple data units corresponding to the surrounding environment (S2230). If the configuration of the first communication node changes during this process, the first communication node may transmit configuration change information to the second communication node (S2240).

Based on the configuration change information received from the first communication node, the second communication node may transmit a data request signal to the first communication node (S2250). The first communication node may transmit the collected multiple data units to the second communication node based on the data request signal. In this case, the first communication node may transmit the multiple data units collected up to a time point just before the configuration change to the second communication node (S2260).

The second communication node may classify and store the multiple data units transmitted by the first communication node according to corresponding intelligent functionalities. The second communication node may transmit a dataset, including one or more data units corresponding to the preconfigured intelligent functionality of the first communication node, to the first communication node. The first communication node may acquire the dataset transmitted by the second communication node as a training dataset (S2270).

Referring again to FIG. 7, the first communication node may train the intelligent model using the acquired training dataset so that the intelligent model operates according to the configured intelligent functionality (S730).

As described above, the first communication node may acquire the dataset received from the second communication node as a training dataset and train the intelligent model using the dataset. Additionally, in exemplary embodiments of the present disclosure, the first communication node may acquire the multiple data units it has collected as a training dataset and train the intelligent model using the training dataset. Here, the first communication node may train the intelligent model through supervised learning or unsupervised learning.

FIGS. 23 to 27 are sequence charts illustrating exemplary embodiments of methods for training an intelligent model using a training dataset.

Referring to FIG. 23, the first communication node may configure at least one intelligent functionality (S2310) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the second communication node may transmit a dataset to the first communication node (S2320). Here, the second communication node may transmit dataset information to the first communication node, share the dataset information with the first communication node, and then transmit the dataset corresponding to the shared dataset information. Additionally, in some exemplary embodiments of the present disclosure, the second communication node may transmit the dataset along with the dataset information to the first communication node.

The first communication node may acquire the dataset received from the second communication node as a training dataset. Using the acquired training dataset, the first communication node may perform training of the intelligent model so that the intelligent model performs a specific intelligent functionality, in other words, the configured intelligent functionality (S2330).

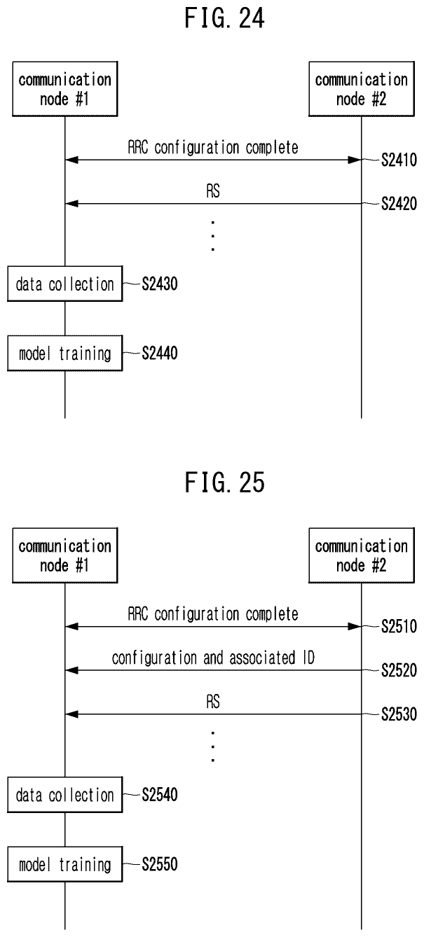

Referring to FIG. 24, the first communication node may configure at least one intelligent functionality (S2410) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the second communication node may transmit reference signals (RSs) to the first communication node (S2420). Here, the RS may be a signal that indicates a start of data unit collection by the first communication node, and the second communication node may sequentially transmit multiple RSs at preconfigured intervals.

The first communication node may collect multiple data units based on the RSs received from the second communication node (S2430). Each time the RS is received from the second communication node, the first communication node may collect data units at a time of receiving the RS and store them.

When the last RS is received from the second communication node, the first communication node may acquire a training dataset that includes the data units collected according to the last RS along with the previously collected data units. Using the acquired training dataset, the first communication node may perform training of the intelligent model so that the intelligent model performs the configured intelligent functionality (S2440).

Meanwhile, during the data collection step, the first communication node may collect data units unrelated to the configured intelligent functionality. These data units may degrade the training performance of the intelligent model. Accordingly, the second communication node may control the data collection of the first communication node to ensure that the first communication node collects data units that align with the configured intelligent functionality.

Referring to FIG. 25, the first communication node may configure at least one intelligent functionality (S2510) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the second communication node may transmit configuration information and associated ID for data collection to the first communication node (S2520). Here, the associated ID may be associated with the configured intelligent functionality of the first communication node.

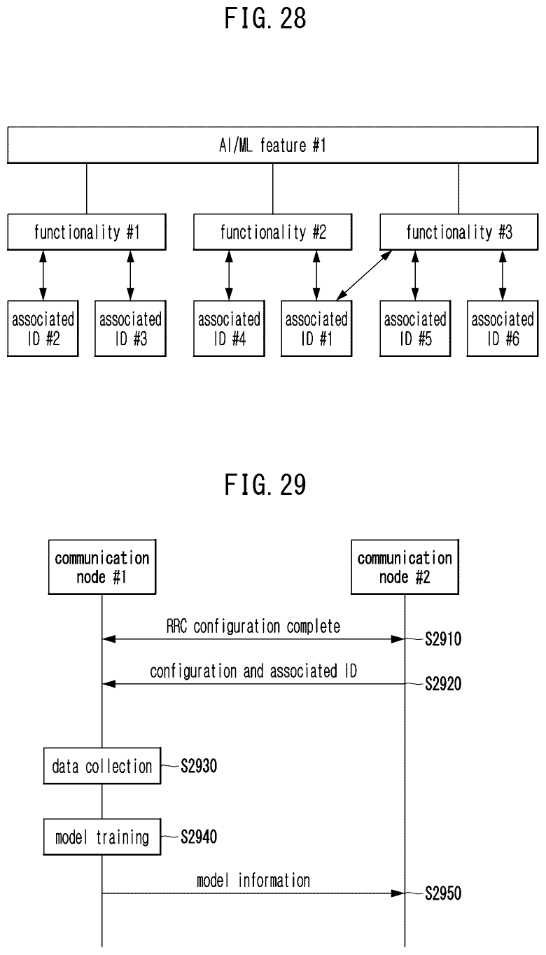

FIG. 28 is a conceptual diagram illustrating a relationship between intelligent functionalities and associated IDs.

Referring to FIG. 28, one intelligent feature of the first communication node may include multiple intelligent functionalities, and the multiple intelligent functionalities may be associated with respective associated IDs.

Each of the multiple associated IDs represents information for the first communication node's data collection and, as described with reference to FIG. 11, may ensure consistency in performance between training of the intelligent model and its actual intelligent operation. For example, each associated ID may serve as an identifier capable of conveying configuration changes for intelligent functionality of either the first communication node or the second communication node.

As such, since each of the multiple associated IDs is associated with the configured intelligent functionality of the first communication node, the data units collected by the first communication node or the training dataset acquired by the first communication node may depend on the associated ID.

Referring again to FIG. 25, the second communication node may sequentially transmit multiple RSs to the first communication node at predefined intervals (S2530). The first communication node may collect data units corresponding to the associated ID previously transmitted each time the RS is received (S2540).

When the last RS is received from the second communication node, the first communication node may acquire a training dataset that includes the data units collected based on the last RS along with the previously collected data units. Using the acquired training dataset, the first communication node may train the intelligent model to perform the preconfigured intelligent functionality (S2550).

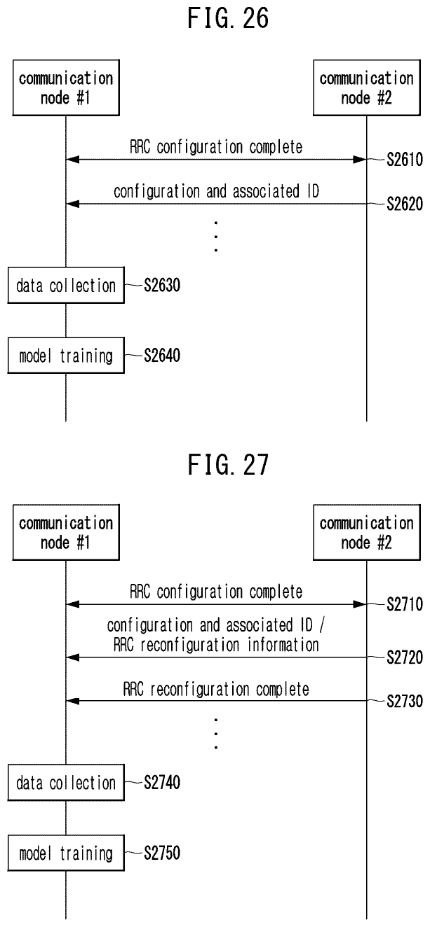

Referring to FIG. 26, the first communication node may may configure at least one intelligent functionality (S2610) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the second communication node may transmit configuration information and associated ID for data collection to the first communication node (S2620). Here, the associated ID may be associated with the configured intelligent functionality of the first communication node.

The first communication node may collect multiple data units corresponding to the associated ID received from the second communication node (S2630). The first communication node may acquire the collected data units as a training dataset and use the training dataset to train the intelligent model to perform the preconfigured intelligent functionality (S2640).

Referring to FIG. 27, the first communication node may configure at least one intelligent functionality (S2710) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the second communication node may transmit configuration information and associated ID to the first communication node and may also transmit functionality reconfiguration information, such as RRC reconfiguration information, to reconfigure the intelligent functionality of the first communication node (S2720).

The first communication node may reconfigure the configured intelligent functionality based on the functionality reconfiguration information received from the second communication node and transmit a reconfiguration completion report to the second communication node (S2730).

After the intelligent functionality of the first communication node is reconfigured, the first communication node may collect multiple data units corresponding to the received associated ID (S2740), acquire the collected data units as a training dataset, and train the intelligent model (S2750).

FIGS. 29 to 31 are sequence charts illustrating other exemplary embodiments of methods for training an intelligent model using training datasets, and FIG. 32 is a conceptual diagram illustrating a relationship among intelligent functionalities, associated IDs, and model IDs.

The exemplary embodiments for training an intelligent model in functionality-based LCM have been described with reference to FIGS. 23 to 27. However, as described above, even in the functionality-based LCM of the present disclosure, model-based LCM may be performed in specific scenarios. This will be described in more detail with reference to FIGS. 29 to 32.

Referring to FIG. 29, the first communication node may configure at least one intelligent functionality (S2910) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the second communication node may transmit configuration information and associated ID for data collection to the first communication node (S2920). As described above, the associated ID may be associated with the configured intelligent functionality of the first communication node.

The first communication node may collect multiple data units corresponding to the associated ID received from the second communication node (S2930). The first communication node may acquire the collected multiple data units as a training dataset and use the training dataset to train the intelligent model so that the intelligent model performs the preconfigured intelligent functionality (S2940).

Once the training of the intelligent model in the first communication node is completed, the first communication node may transmit information on the trained intelligent model to the second communication node for sharing (S2950). The model information may include a model ID associated with the intelligent model, and the model ID may be configured either by the first communication node or by the second communication node.

Referring to FIG. 32, one intelligent feature of the first communication node may include multiple intelligent functionalities, and each of the multiple intelligent functionalities may be associated with respective associated IDs.

Each model ID may correspond to each of intelligent models of the first communication node. Each model ID may also correspond to one associated ID, and each intelligent model may be trained by using multiple data units collected based on the corresponding associated ID as a training dataset. In some exemplary embodiments, each model ID may correspond to two or more associated IDs, and each intelligent model may be trained by using multiple data units collected based on the corresponding two or more associated IDs as a training dataset.

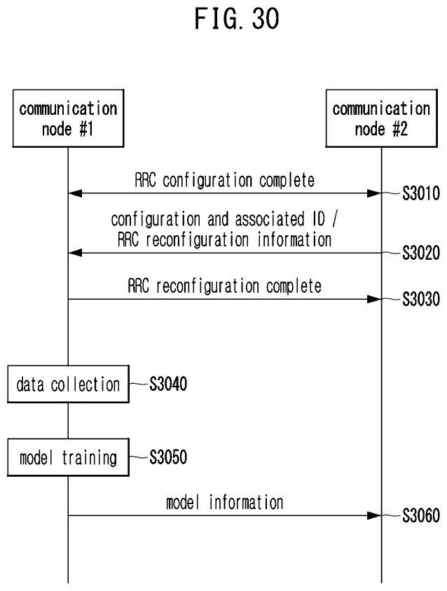

Referring to FIG. 30, the first communication node may configure at least one intelligent functionality (S3010) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the second communication node may transmit configuration information and associated ID to the first communication node and, additionally, may transmit functionality reconfiguration information to reconfigure the intelligent functionality of the first communication node (S3020).

The first communication node may reconfigure the configured intelligent functionality based on the functionality reconfiguration information received from the second communication node and transmit a reconfiguration completion report to the second communication node (S3030).

After the intelligent functionality of the first communication node is reconfigured, the first communication node may collect multiple data units corresponding to the associated ID (S3040), acquire the collected data units as a training dataset, and train the intelligent model (S3050). Once the training of the intelligent model in the first communication node is completed, the first communication node may transmit information on the trained intelligent model to the second communication node for sharing (S3060). Here, the model information may include the model ID associated with the intelligent model.

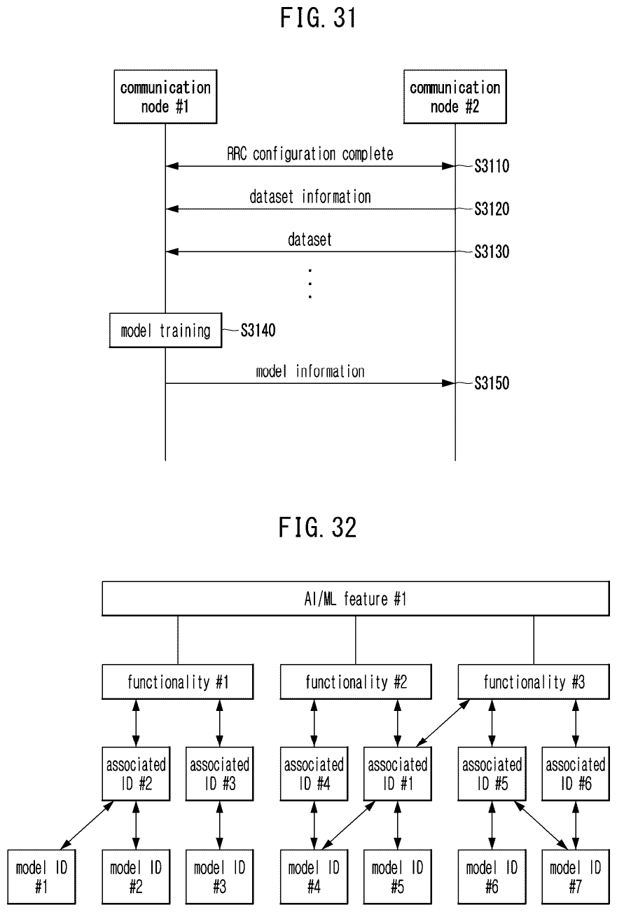

Referring to FIG. 31, the first communication node may configure at least one intelligent functionality (S3110) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the second communication node may transmit dataset information corresponding to the configured intelligent functionality to the first communication node. Accordingly, the first communication node and the second communication node may share the dataset information (S3120). Additionally, in some exemplary embodiments of the present disclosure, the second communication node may transmit the dataset information to the first communication node along with the functionality configuration information for configuring the intelligent functionality.

In the state where the first communication node and the second communication node share the dataset information, the second communication node may transmit a dataset, including one or more data units corresponding to the shared dataset information, to the first communication node. Accordingly, the first communication node may acquire the dataset received from the second communication node as a training dataset (S3130).

The first communication node may perform training of the intelligent model using the acquired training dataset (S3140). Once the training of the intelligent model in the first communication node is completed, the first communication node may transmit information on the trained intelligent model to the second communication node for sharing (S3150).

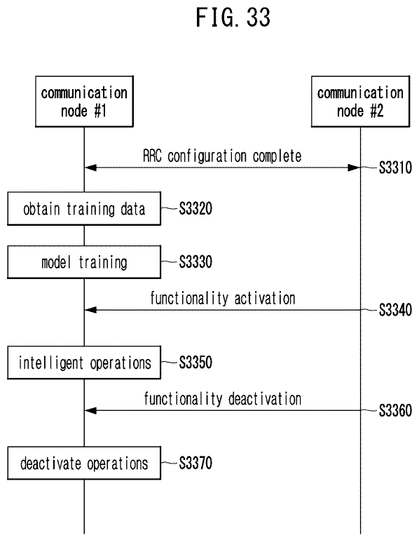

FIG. 33 is a sequence chart illustrating exemplary embodiments of an intelligent operation method for a communication node using an intelligent model.

Referring to FIG. 33, the first communication node may configure at least one intelligent functionality (S3310) through a step of receiving a node capability information request from the second communication node; a step of transmitting a capability report to the second communication node; a step of receiving functionality configuration information from the second communication node; and a step of configuring at least one intelligent functionality based on the functionality configuration information and transmitting a configuration completion report to the second communication node.

After the intelligent functionality of the first communication node is configured, the first communication node may acquire a training dataset for training the intelligent model (S3320). The training dataset may be acquired either from the dataset received from the second communication node based on the dataset information shared with the second communication node or from multiple data units collected by the first communication node itself based on the associated ID received from the second communication node.

The first communication node may perform training of the intelligent model using the training dataset so that the intelligent model performs the configured intelligent functionality (S3330).

Once the training of the intelligent model in the first communication node is completed, the second communication node may transmit a functionality activation signal to the first communication node (S3340). Based on the received functionality activation signal, the first communication node may install the trained intelligent model and perform intelligent operations according to the intelligent functionality corresponding to the functionality activation signal using the installed intelligent model (S3350).

Once the intelligent operation of the intelligent model in the first communication node is completed, the second communication node may transmit a functionality deactivation signal to the first communication node (S3360). The first communication node may deactivate the intelligent operation of the intelligent model based on the received functionality deactivation signal (S3370).

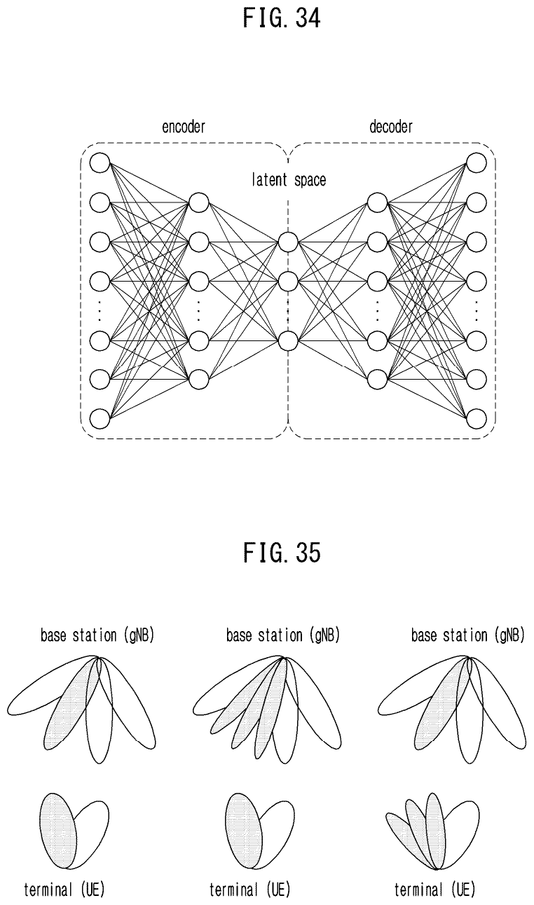

FIGS. 34 to 36 are conceptual diagrams illustrating exemplary embodiments to which intelligent techniques are applied.

Referring to FIG. 34, intelligent techniques may be utilized in a channel information feedback method in which a terminal reports channel state information (CSI) to support application of transmission techniques such as Multiple Input Multiple Output (MIMO) or precoding in the communication system.

For example, in a channel information feedback method, intelligent techniques may be applied as an autoencoder. An autoencoder to which the intelligent technique is applied may be configured with a hidden layer between the encoder and decoder having fewer neurons than the input layer, enabling data compression (or dimensionality reduction). Using the intelligent technique-applied autoencoder, channel compression (CSI compression) may be performed to obtain compressed latent representations of an MIMO channel.

Referring to FIG. 35, intelligent techniques may be utilized in a beam management method to enhance an arrival distance of directional beams in a communication system.

For example, when directional beams are used in a communication system, a process may be required to select a transmission (Tx) beam and a reception (Rx) beam that exhibit the optimal performance between the base station and the terminal to ensure stable link performance. In the conventional beam management method, frequent overhead may occur during selection of the optimal beam, potentially resulting in performance degradation and increased power consumption.

A beam management method to which the intelligent technique is applied may reduce the overhead caused during beam measurements for optimal beam selection and improve the accuracy of selecting the optimal beam. Additionally, the beam management method to which the intelligent technique is applied may be used for beam prediction, which predicts beams of unobserved resources in the spatial or temporal domains.

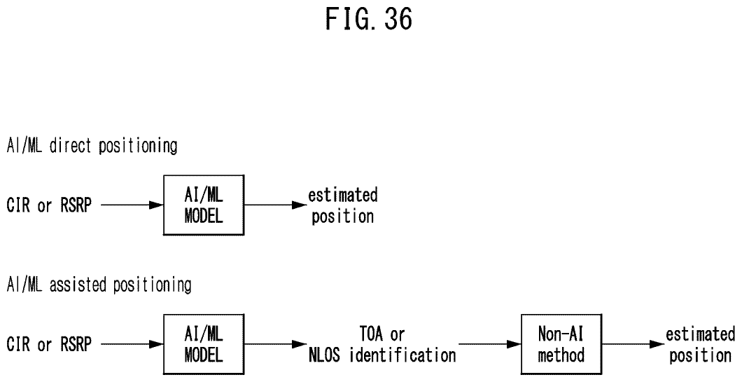

Referring to FIG. 36, intelligent techniques may be utilized in a positioning method for estimating a location of a specific terminal in a communication system.

For example, a positioning method to which the intelligent technique is applied may improve the accuracy of measurements used for estimating the terminal's location. The positioning method to which the intelligent technique is applied may include direct positioning methods using intelligent models such as AI/ML models and assisted positioning methods using AI/ML models.

The direct positioning method may involve an AI/ML model that takes channel impulse response (CIR) signals or reference signal received power (RSRP) as inputs and outputs the estimated location of the terminal. The assisted positioning method may involve an AI/ML model that takes CIR signals or RSRP as inputs to output a time of arrival (TOA) or a non-line-of-sight (NLOS) identification result, which is then used to estimate the terminal's location.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first communication node, comprising:
configuring at least one intelligent functionality among a plurality of intelligent functionalities based on functionality configuration information received from a second communication node;
obtaining a training dataset corresponding to the at least one intelligent functionality based on an associated identifier (ID) received from the second communication node;
training an intelligent model to perform the at least one intelligent functionality using the training dataset; and
performing intelligent operations according to the at least one intelligent functionality using the trained intelligent model.

2. The method according to claim 1, wherein the configuring of the at least one intelligent functionality comprises:
in response to a capability information request received from the second communication node, transmitting, to the second communication node, a capability report including information on each of the plurality of intelligent functionalities supportable by the first communication node;
in response to the functionality configuration information received from the second communication node based on the capability report, configuring the at least one intelligent functionality corresponding to the functionality configuration information among the plurality of intelligent functionalities; and
transmitting a completion report to the second communication node upon completion of the configuring of the at least one intelligent functionality.

3. The method according to claim 1, further comprising: after configuring the at least one intelligent functionality,
transmitting additional information to the second communication node;
receiving functionality reconfiguration information from the second communication node based on the additional information; and
reconfiguring the at least one intelligent functionality by incorporating the additional information based on the functionality reconfiguration information.

4. The method according to claim 1, further comprising: after configuring the at least one intelligent functionality,
receiving additional information and functionality reconfiguration information from the second communication node; and
reconfiguring the at least one intelligent functionality by incorporating the additional information based on the functionality reconfiguration information.

5. The method according to claim 1, wherein the obtaining of the training dataset comprises:
receiving dataset information corresponding to the at least one intelligent functionality from the second communication node; and
receiving a dataset corresponding to the dataset information from the second communication node and acquiring the dataset as the training dataset.

6. The method according to claim 1, wherein the obtaining of the training dataset comprises:
collecting a plurality of data units based on data collection configuration information received from the second communication node;
in response to receipt of a data request signal from the second communication node, transmitting the plurality of data units to the second communication node; and
receiving a dataset including one or more data units corresponding to the at least one intelligent functionality among the plurality of data units from the second communication node and acquiring the dataset as the training dataset.

7. The method according to claim 6, wherein the obtaining of the training dataset comprises: transmitting configuration change information of the first communication node to the second communication node, and the transmitting of the plurality of data units to the second communication node comprises: transmitting the plurality of data units collected up to a time of changing configuration of the first communication node to the second communication node upon receipt of a data request signal transmitted from the second communication node based on the configuration change information.

8. The method according to claim 1, wherein the obtaining of the training dataset comprises:
receiving the associated ID and reference signals (RSs) from the second communication node; and
collecting a plurality of data units corresponding to the at least one intelligent functionality based on the RSs and the associated ID and acquiring the plurality of data units as the training dataset.

9. The method according to claim 1, further comprising: after the training of the intelligent model, transmitting model information for the intelligent model to the second communication node.

10. The method according to claim 1, wherein the performing of the intelligent operations comprises:
operating the intelligent model to perform the at least one intelligent functionality based on a function activation signal received from the second communication node; and
deactivating operations of the intelligent model based on a function deactivation signal received from the second communication node.

11. A first communication node comprising at least one processor, wherein the at least one processor causes the first communication node to perform:
configuring at least one intelligent functionality among a plurality of intelligent functionalities based on functionality configuration information received from a second communication node;
obtaining a training dataset corresponding to the at least one intelligent functionality based on an associated identifier (ID) received from the second communication node;
training an intelligent model to perform the at least one intelligent functionality using the training dataset; and
performing intelligent operations according to the at least one intelligent functionality using the trained intelligent model.

12. The first communication node according to claim 11, wherein in the configuring of the at least one intelligent functionality, the at least one processor causes the first communication node to perform:
in response to a capability information request received from the second communication node, transmitting, to the second communication node, a capability report including information on each of the plurality of intelligent functionalities supportable by the first communication node;
in response to the functionality configuration information received from the second communication node based on the capability report, configuring the at least one intelligent functionality corresponding to the functionality configuration information among the plurality of intelligent functionalities; and
transmitting a completion report to the second communication node upon completion of the configuring of the at least one intelligent functionality.

13. The first communication node according to claim 11, wherein the at least one processor further causes the first communication node to perform: after configuring the at least one intelligent functionality,
transmitting additional information to the second communication node;
receiving functionality reconfiguration information from the second communication node based on the additional information; and
reconfiguring the at least one intelligent functionality by incorporating the additional information based on the functionality reconfiguration information.

14. The first communication node according to claim 11, wherein the at least one processor further causes the first communication node to perform: after configuring the at least one intelligent functionality,
receiving additional information and functionality reconfiguration information from the second communication node; and
reconfiguring the at least one intelligent functionality by incorporating the additional information based on the functionality reconfiguration information.

15. The first communication node according to claim 11, wherein in the obtaining of the training dataset, the at least one processor causes the first communication node to perform:
receiving dataset information corresponding to the at least one intelligent functionality from the second communication node; and
receiving a dataset corresponding to the dataset information from the second communication node and acquiring the dataset as the training dataset.

16. The first communication node according to claim 11, wherein in the obtaining of the training dataset, the at least one processor causes the first communication node to perform:
collecting a plurality of data units based on data collection configuration information received from the second communication node;
in response to receipt of a data request signal from the second communication node, transmitting the plurality of data units to the second communication node; and
receiving a dataset including one or more data units corresponding to the at least one intelligent functionality among the plurality of data units from the second communication node and acquiring the dataset as the training dataset.

17. The first communication node according to claim 16, wherein in the obtaining of the training dataset, the at least one processor causes the first communication node to perform: transmitting configuration change information of the first communication node to the second communication node, and in the transmitting of the plurality of data units to the second communication node, the at least one processor causes the first communication node to perform: transmitting the plurality of data units collected up to a time of changing configuration of the first communication node to the second communication node upon receipt of a data request signal transmitted from the second communication node based on the configuration change information.

18. The first communication node according to claim 11, wherein in the obtaining of the training dataset, the at least one processor causes the first communication node to perform:
receiving the associated ID and reference signals (RSs) from the second communication node; and
collecting a plurality of data units corresponding to the at least one intelligent functionality based on the RSs and the associated ID and acquiring the plurality of data units as the training dataset.

19. The first communication node according to claim 11, wherein the at least one processor further causes the first communication node to perform: after the training of the intelligent model, transmitting model information for the intelligent model to the second communication node.

20. The first communication node according to claim 11, wherein in the performing of the intelligent operations, the at least one processor causes the first communication node to perform:
operating the intelligent model to perform the at least one intelligent functionality based on a function activation signal received from the second communication node; and
deactivating operations of the intelligent model based on a function deactivation signal received from the second communication node.
